(19) United States
(12) Patent Application Publication
(10) Pub. No.: US 2011/0298442 A1
(43) Pub. Date: Dec. 8, 2011

(54) Converter Circuit and Electronic System Comprising Such a Circuit

(75) Inventors: Guy Waltisperger, Grenoble (FR); Cyril Condemine, Izeaux (FR); Jerome Willemin, Tullins (FR)

(73) Assignee: Commissariat a I'energie atomique et aux energies alternatives, Paris (FR)

(21) Appl. No.: 13/152,948

(22) Filed: Jun. 3, 2011

(30) Foreign Application Priority Data
Jun. 4, 2010 (FR) 1054422

(51) Int. Cl. G05F 3/08

(52) U.S. Cl. 323/299

(57) ABSTRACT

A converter circuit for connecting to a source of electrical energy that is capable of major fluctuations in delivered power. The circuit includes a chopper circuit having a variable duty cycle, a variable-size chopper switch and an input terminal connectable to said electric energy source; at least one first output circuit adapted to being connected via a variable-size chopper switch to an output terminal of the chopper circuit; and a control circuit configured to control firstly the duty cycle of the chopper circuit and secondly the size of said variable-size switches as a function of the power delivered by said electrical energy source.

### RELATED APPLICATIONS

This application claims the benefit of the Jun. 4, 2010 priority date of French application FR-1054422, the contents of which are herein incorporated by reference.

### FIELD OF DISCLOSURE

The present disclosure pertains to a converter circuit and to an electronic system comprising such a circuit.

### BACKGROUND OF THE INVENTION

The development of photovoltaic panels has significantly expanded in recent years with a view to the constantly increasing use of renewable energy sources in order to reduce the harmful greenhouse effect caused especially by carbon dioxide emissions.

This is also true of renewable energy sources such as wind or thermo-electrical sources.

These energy sources have the special feature wherein the electrical energy that they provide varies greatly according to the natural phenomena that supply them. Furthermore, a photovoltaic generator is a generator whose characteristic I=f(U) is highly non-linear. Thus, for a same illumination value, the power delivered will be different depending on the load.

Thus, the efficiency, i.e. the power delivered by a photovoltaic cell, depends not only on its exposure to sunlight which varies during the day, but also for example on the concealment of sunlight, for example by shade cast by clouds or other meteorological phenomena.

To transfer the energy produced by these sources, DC-DC converters are used at output of the energy harvesting source. A DC-DC converter of this kind may be a chopper converter used to boost or step down the voltage delivered by the electrical power source. It generally has power selector switches, in particular transistors (for example MOSFET (metal-oxide semiconductor field-effect transistor) type transistors, JFET (junction field-effect transistors) or BJT (bipolar transistors)) to transfer energy towards an output circuit.

However, according to a first aspect, these switches are also the source of energy harvesting losses, which affects overall energy harvesting efficiency.

In particular, it must be noted that there are resistive losses and switching losses in these electronic components.

If the DC-DC converter is designed for higher currents, large-sized power selector switches are needed.

However, when the power tapped is low, the dynamic consumption for the switching causes the overall efficiency of the system to drop.

If the DC-DC converter is designed for low currents, then small-sized power selector switches are needed.

However, when the current tapped is high, these selector switches show a major resistive loss which also causes the overall efficiency of the system to drop.

At present therefore there is a problem of finding an appropriate compromise when choosing the size of the power switches.

Furthermore, in a second aspect, when photovoltaic cells are for example connected to a load such as a consumer (for example a sensor or again a battery to be recharged), it turns out to be the case that the power transferred to the load does not generally correspond to the maximum power that can be delivered by the cell. Similar problems can be noted for wind energy. The result of this is not only that the efficiency drops for example because of weaker sunlight, but also that this efficiency is adversely affected by an imposed operating point situated below the potential performance of the cell.

In order to overcome this drawback and produce energy that is consistently as close as possible to the optimum operating point, circuits are used implementing a method known as the maximum power point tracking (MPPT) method which has been known since 1968. This is a method providing a better connection between a non-linear source and an arbitrary load.

These circuits are designed to force the generator, for example the photovoltaic cell, to work at its maximum power point, thus inducing improved efficiency.

An MPPT controller therefore drives the static converter connecting the load (a battery for example) and a photovoltaic panel so as to permanently provide maximum power to the load.

There are known ways, in maximum power point or MPP tracking, of applying a method based on a disturbance-observation approach.

In the case of a photovoltaic application, this is in fact an algorithm which, for a fixed voltage U1, will measure the corresponding power value P1 delivered by the generator, and then, after a certain period of time, dictate a voltage U2=U1+ΔU and also measure the corresponding power value P2. Thereafter, a voltage U3=U2+ΔU, is imposed if P2 is greater than P1. If not U3=U2−ΔU is imposed.

However, this implies measurements of current and also entails major computation resources that consume non-negligible amounts of energy. This is why, in a large-sized photovoltaic installation, a sub-group of cells is dedicated exclusively to providing the energy needed to control the MPPT circuit.

However, in electronic micro-systems, such as for example autonomous sensors, this approach is not acceptable because the constraints in terms of space requirement and weight are great and it is necessary to have a system that is as small as possible with increased autonomy.

There also exist known maximum power point tracking circuits that possess an additional driver cell, which is not always desirable.

There also exist MPPT circuits without driver cells based on voltage sampling in an open circuit performed by disconnecting the photovoltaic panel at a fixed frequency from the rest of the circuit to measure the voltage in an open circuit. The system then reconnects the panel to the harvesting circuit which has taken the new optimized parameters into account. The result of this however is a frequent interruption of the energy harvesting process, which is unacceptable for electronic micro-systems designed to be autonomous.

In information technology, there is a known document US2006/0038543 describing a DC-DC converter circuit that uses variable-size power switches that can be adjusted to reduce switch-related losses.

However, the circuit described in this document is designed to adapt to an environment determined by the consumption and requirements of the load and is not adapted to energy sources that could show major fluctuations in power delivered.

### SUMMARY

The present invention is designed to at least partially overcome the above-mentioned drawbacks.

According to one aspect, the invention seeks to diminish the losses of the converter circuit.

According to another aspect, the invention seeks to optimize energy harvesting while at the same time substantially reducing the space requirement of the system, especially the size of the generator, for example, the size of the photovoltaic panel or wind generator as well as the size of the backup accumulator, for example a battery or a super-capacitor.

To this end, the present invention features a converter circuit to be connected to a source of electric energy capable of major fluctuations in power delivered. The circuit includes:
a chopper circuit with variable duty cycle, comprising a variable-size chopper switch and an input terminal connectable to the electric energy source, and
at least one first output circuit adapted to being connected via a variable-size chopper switch to an output terminal of the chopper circuit;
a control circuit configured to control firstly the duty cycle of the chopper circuit and secondly the size of the variable-size switches as a function of the power delivered by the electrical energy source.

Various embodiments of the converter circuit possesses one or more of following characteristics, taken alone or in combination:

In one aspect, the control circuit is configured to control the size of the variable-size switches as a function of the duty cycle (α).

According to another aspect, the control circuit is configured for maximum power point tracking (MPPT).

This MPPT method is for example implemented by the control circuit configured to determine a power point (MPPT) according to the variation in voltage of the electrical energy source.

According to yet another aspect, each of the variable-size switches comprises at least two individual switches that are parallel-mounted and selectively switchable according to a command from the control circuit.

In a first variant, the individual switches have the same sizes.

In a second alternative variant, the individual switches have increasing sizes.

In the latter case, it is possible for example to plan that the individual switches will have sizes that increase by multiples of two.

In yet another aspect, the control circuit is configured to command an increase in the size of the variable-size switches as a function of an increase in the power delivered by the energy source.

It can also be planned that the control circuit will be configured to control the size of the variable-size switches as a function of predefined ranges of set values of power delivered by the energy source.

The control circuit may be configured to control the chopper circuit in discontinuous operation mode.

In another embodiment, the converter circuit comprises a second output circuit adapted to being connected via a second variable-size switch to the output terminal of the chopper circuit, and wherein the control circuit is configured to command the switching of the first and second switches as a function of a range of set values of output voltage for the first output circuit.

According to one aspect, the first output circuit is to be connected to an electrical load working in the range of set values of voltage, wherein the second output circuit is to be connected to an electrical energy accumulator.

According to another aspect, the control circuit comprises a hysteresis comparator having one input connected to a first output circuit and the other input connected to a reference, the output of the comparator being connected to an input of a control unit controlling a command generator, two outputs of which are respectively connected to the second and first switches in order to drive them respectively.

Furthermore, the electrical energy accumulator may be a rechargeable micro-battery, and/or a super-capacitor.

The output circuits comprise for example low-pass filters.

In yet another aspect, the control circuit furthermore comprises means to:
determine the voltage of the terminals of the electrical energy source for two duty cycles that differ by a predefined quantity,
compute the difference between the voltages obtained for two duty cycles that differ by a predefined quantity,
compare this voltage difference with a value of voltage difference obtained previously, and
command a change in the duty cycle by a predetermined quantity as a function of the result of the comparison.

It is planned for example that the control circuit will be configured to command an increase in the duty cycle by a predefined quantity if a previous reduction of the duty cycle had resulted in a reduction of the difference in voltage relatively to that obtained during the predetermined determining operation.

Then, the control circuit can be configured to command a reduction in the duty cycle by a predefined quantity if a previous increase in the duty cycle had resulted in a reduction in the difference in voltage relatively to that obtained during the previous determining operation.

According to a non-exhaustive example, the chopper circuit comprises an electrical energy accumulation inductor and at least one chopper switch controlled by the control circuit.

According to a first variant, the electrical energy accumulation inductor and the chopper switch are laid out in a voltage-boosting configuration.

According to an alternative variant, the electrical energy accumulation inductor and the chopper switch are laid out in a voltage-step-down configuration.

The control circuit may include a sensor of the zero current point of the electrical energy accumulation inductor to trigger the control of at least one switch.

An object of the invention is also an electronic system comprising at least one electrical energy source capable of undergoing major fluctuations and at least one converter circuit as defined here above connected to at least one energy source.

According to one or more characteristics of the electronic system, taken alone or in combination:
the source comprises at least one photovoltaic cell,
the source comprises at least one wind power generator,
the source comprises at least one thermo-electrical element,
the output of each energy source is connected to the input of an associated converter circuit and each of the second output circuits of the converter circuits includes a super-capacitor.

Other features and advantages shall appear more clearly from the following description of the invention as well as from the following figures, of which:

### BRIEF DESCRIPTION OF THE DRAWINGS

FIG. 1 is a diagram of an electronic system with a converter circuit according to a first embodiment,

FIG. 2 is a an example of an electric circuit diagram of a variable-size switch,

FIG. 3 is a flowchart illustrating the maximum power point tracking method,

FIG. 4 is a diagram of an electronic system with a converter circuit according to a second embodiment,

FIG. 5 is a schematic graph of the controls of the transistors of the converter circuit according to the second embodiment, as a function of time,

FIG. 6 is a diagram of an electrical system according to another embodiment.

In all the figures, identical elements carry the same reference numbers.

### DETAILED DESCRIPTION

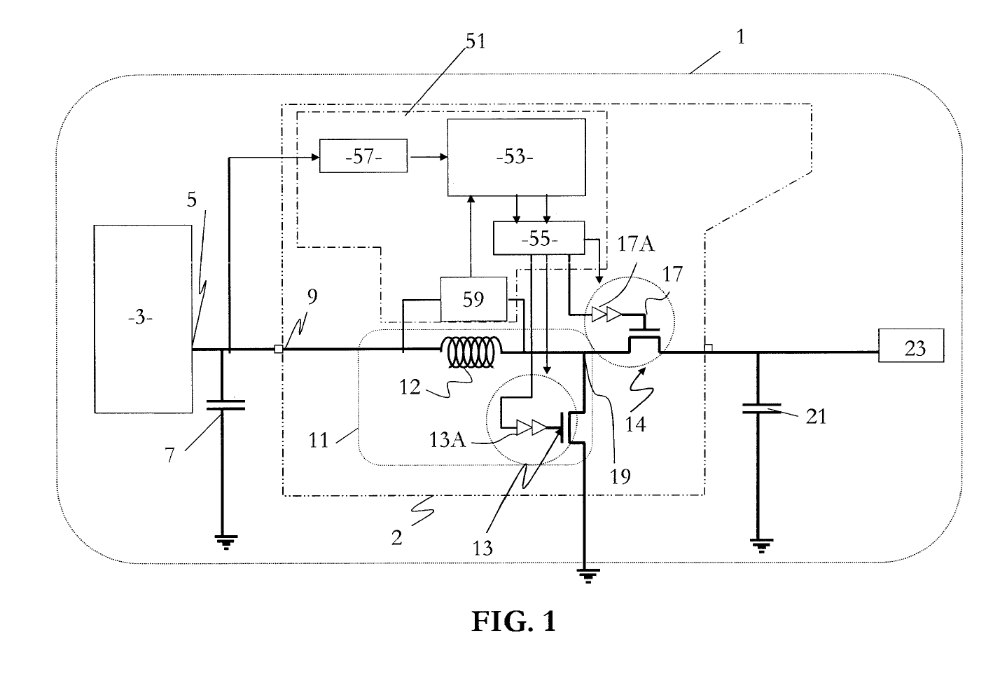

FIG. 1 shows an example of a diagram of an electronic system 1 comprising a converter circuit 2 and an electrical energy source 3 connected to the converter circuit 2.

The electrical energy source 3 which can show major fluctuations in delivered power is for example a solar cell or solar panel, a thermo-electrical element or again a wind power generator, in particular a small-sized unit.

The term “major fluctuations” is understood to mean fluctuations by a factor of 100 between the lowest value of power and the highest value of power that can be delivered by a source 3 such as this.

One output 5 of this source 3 is connected through a low-pass filter 7, formed by a capacitor, to an input terminal 9 of the converter circuit 2.

The converter circuit 2 has a chopper circuit 11, the input terminal of which forms the input terminal 9 of the converter circuit 2 connected to the electrical energy source 3.

The chopper circuit 11 comprises an electrical energy accumulation inductor 12 and at least one variable-size chopper switch 13.

In FIG. 1, the electrical energy accumulation inductor 12 and the variable-size chopper switch 13 are laid out in a voltage-boosting configuration (also called a “boost configuration”), i.e. the input of the inductor is connected to the source 3 and the output of the inductor 12 can be connected to ground if the switch 13 is in the “on” state to enable a magnetic field to be set up around the inductor 12. The chopper frequency is for example 200 kHz.

According to one variant, not shown, the electrical energy accumulation inductor 12 and the chopper switch 13 can also be arranged according to a voltage step-down configuration.

A converter circuit furthermore comprises a first output circuit 14.

Upstream, this first output circuit 14 is connected via a first variable-size switch 17 to an output terminal 19 of the chopper circuit 11.

Downstream, this first output circuit 14 is connected through a low-pass filter 21 to an electrical load 23 belonging to the electronic system 1 and working in a predefined range of set values of voltage.

To optimize the electrical consumption of the converter, both the switch 13 and the switch 17 are therefore variable-size switches.

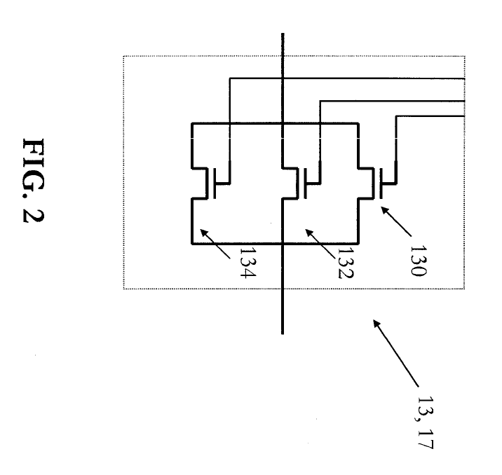

By way of an example, one possible embodiment of a variable-size switch is shown in FIG. 2.

Thus, a variable-size switch 13 or 17 in FIG. 1 corresponds to a set of several parallel-connected switches as shown in FIG. 2.

For example, each of the variable-size switches 13 and 17 includes at least two or (as, in the figure, three) individual switches 130, 132 and 134 parallel-mounted and selectively switchable as a function of a command.

It can be planned that these individual switches 130, 132 and 134 will all be of the same size i.e. identical.

Thus, if there is need for a small-sized switch, hence a switch with low switching losses but with greater resistive losses, then only one of the individual switches is switched to the “on” state.

If a large-sized switch is needed, hence a switch with low resistive losses but with greater switching losses, then several or even all the individual switches are switched simultaneously to the “on” state.

As a variant, it can be planned that the individual switches 130, 132 and 134 will have sizes in ascending order, especially ascending by multiples of 2, i.e. the size of the individual switch 134 is twice that of the switch 132 which itself has a size twice that of the switch 130.

Thus, the range of dimensions can be extended by judicious combinations of switches, simultaneously switched over to the “on” state.

The converter circuit 2 is driven by a control circuit 51.

This control circuit 51 has a control unit 53 controlling firstly the duty cycle α of the chopper circuit 11 and therefore its variable-size switch 13 and secondly the switching of the first variable-size switch 17 as shall be described in detail here below.

To this end, the control unit 53 includes a PWM (pulse-width modulation) output controlling a generator 55 for controlling the switches 13 and 17 (also called DTLC or dead time control logic) units.

With regard to the switch 13, it must be noted that these are NMOS type transistors, the bases of which connect via buffers (also called delay lines) 13A to the output of the generator 55.

For the switch 17, these are PMOS transistors, the bases of which is connect via buffers 17A to associated outputs of the generator 55.

The control circuit 51 furthermore includes means to determine the voltage of the terminals of the electrical energy source at two successive instants.

To this end, the invention uses for example an analog-to-digital converter 57 having one input connected to the terminal 5 and one output connected to a corresponding unit of the control unit 53.

For the control of the switch 17 in particular, the control circuit 51 has a zero-current-point sensor 59 to determine the cancellation of the current through the accumulation inductor 12, this sensor 59 delivering a signal to a corresponding input of the control unit 53.

According to one variant that is not shown, it is possible to envisage replacing the zero-current-point sensor by a diode with a very low voltage threshold that is parallel-mounted with a switch.

In operation, the control unit 53 controls the generator 55 so that:

when the switch 13 is closed (on), the switch 17 is open (off),

when the switch 17 is closed (on), the switch 13 is open (off).

Thus, at a given point in time, only one of the switches 13 or 17 can be open.

The control circuit can be configured to command the chopper circuit 11 in a discontinuous mode of operation, i.e. a mode in which the current is periodically cancelled in the inductor 12.

Here below, a detailed description shall be given of the converter circuit 2 of FIG. 1.

The control circuit 51 is configured to control firstly the duty cycle α of the chopper circuit 11 and secondly the sizes of the variable-size switches 13 and 17 as a function of the power delivered by the electrical energy source 3.

The inventors have noted that there is a ratio of proportionality between the power delivered by the source 3 and the duty cycle α. Indeed, the delivered power increases according to the duty cycle.

Thus, the control circuit 51 is configured to command an increase in the size of the variable-size switches 13 and 17 as a function of an increase in the power delivered by the energy source or more simply as a function of the duty cycle α.

For the implementation, for example the control circuit 51 is configured to control the size of the variable-size switches 13 and 17 as a function of predefined ranges of set values of power delivered by the energy source 3.

Furthermore, in order to adapt the size of the switches 13 and 17, it is planned to make the source 3 work always around the maximum power point MPP.

It has proved to be highly advantageous to consider a combination in which the duty cycle α is determined according to an MPPT method so as to tap the energy at the optimum power point and use this optimal duty cycle to control the sizes of the switches 13 and 17.

To this end, the inventors of the present invention have noted that the derivative of the operating voltage of the source 3 as a function of the duty cycle has a maximum value around the maximum power point MPP. The result of this is that tracking the maximum value of this voltage derivative is equivalent to tracking the maximum power point.

Thus, as can be seen, simple measurements of voltages and subtraction and comparison operations that use very little energy and computation power can be used to make the converter circuit 2 work around the maximum power point MPP which is highly advantageous if little power is available.

Furthermore, the losses at the switches can be reduced without carrying out specific measurements.

To this end, the control unit 53 controls the duty cycle α of the chopper circuit 11 as a function of the voltage variation (the derivative as a function of the duty cycle) of the electrical energy source by:

determining the voltage at the terminals of the electrical energy source for two duty cycles differing by a predefined quantity,

computing the difference between two voltages obtained for two duty cycles differing by a predefined quantity,

comparing this voltage difference with a value of voltage difference obtained previously, and

commanding a change of duty cycle by a predefined quantity as a function of the comparison result.

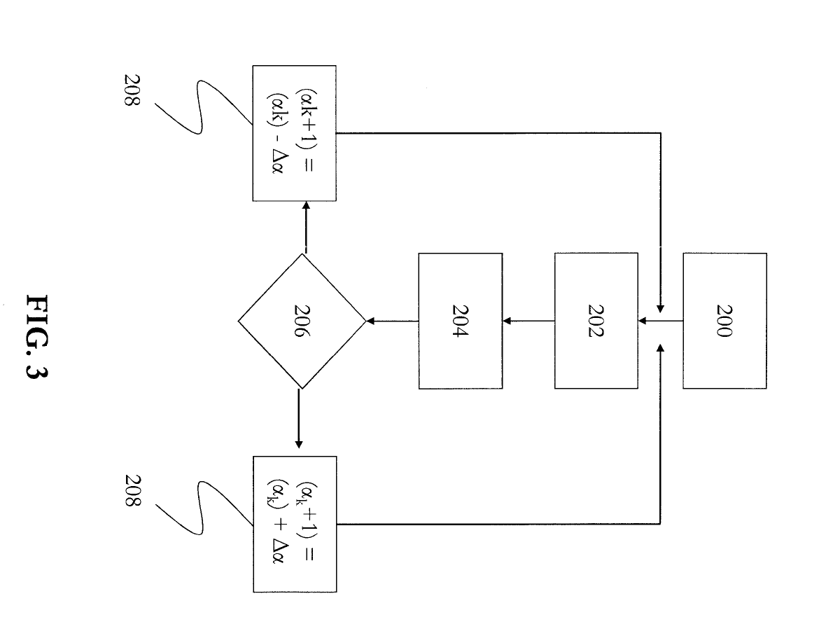

These different steps are described in detail in FIG. 3.

At an initialization step 200, the value of the duty cycle α is set at a predefined value, for example at α=0.5 and the voltage V_{S}(α) at the terminals of the source 3 is determined.

Then, the duty cycle is made to vary by a predefined quantity Δα, and the voltage V_{S}(α+Δα) at the terminals of the electrical energy source 3 is determined again.

Then, the absolute value of the difference between these two voltages is computed:

ΔVⁱⁿⁱ_{S}=|V_{S}(α)−V_{S}(α+Δα)|

As a variant, it is also possible to set ΔVⁱⁿⁱ_{S} at a predefined value.

Then, the actual control loop functioning by recurrence is started.

At a step 202, for a loop k (k being an integer) the voltage V_{S}(αₖ) at the terminals of the source 3 is determined.

At a step 204, the absolute value of the difference between these two measured voltages for the loop k and k−1 is computed:

ΔV_{S}(k)=|V_{S}(αₖ)−V_{S}(αₖ₋₁)|;

where |(αₖ)−(αₖ₋₁)|=Δα

Then, at the step 206, this voltage difference ΔV_{S}(k) is compared with a previously obtained value of voltage difference ΔV_{S}(k−1).

Depending on the result of the comparison, the control unit 53 commands the change in duty cycle by a predefined quantity Δα at the step 208.

Thus, the control circuit 51 is configured to command an increase in the duty cycle by the predefined quantity Δα if a previous reduction of the duty cycle had resulted in a reduction of the voltage difference as compared with the difference obtained during the previous determining operation.

In other words,

if (αₖ)=(αₖ₋₁)−Δα and

if ΔV_{S}(k)<ΔV_{S}(k−1), then

(αₖ₊₁)=(αₖ)+Δα.

If not, the control circuit 51 is configured to command a reduction of the duty cycle by a predefined quantity Δα if a previous increase in the duty cycle had resulted in a reduction of the difference in voltage as compared with the difference obtained during the previous determining operation,

In other words,

if (αₖ)=(αₖ₋₁)+Δα and

if ΔV_{S}(k)<ΔV_{S}(k−1),

then (αₖ₊₁)=(αₖ)−Δα.

After the step 208, the operation returns to the step 202,

Thus, the converter circuit oscillates around the maximum power point MPP, guaranteeing the recovery of a maximum level of power available at the source.

The maximum power point MPP tracking frequency or refresh frequency of the duty cycle, i.e. the frequency for performing the steps 202 to 208, is of the order of about ten Hertz, for example 16 Hz.

It can be planned that the frequency for adapting the size of the switches 13 and 17 goes together with the maximum power point (MPP) tracking frequency.

It can also be noted that the smaller the value of Δα, the closer to the optimum maximum power point will the circuit be capable of operating. In this case, a higher refresh frequency is chosen to enable faster adaptation of the duty cycle in the event of a change in operating conditions.

As stated here above, when the switch 13 is closed, the switch 17 is open and the inductor is crossed by a current given by the source 3 setting up a magnetic field.

When the switch 13 is open, the electrical energy can be provided directly to the load 23. The output circuit 14 therefore works together with the chopper circuit 11 like a voltage regulator.

Thus when the switch 13 is open, the switch 17 opens if the output voltage is contained within a range of set values of output voltage.

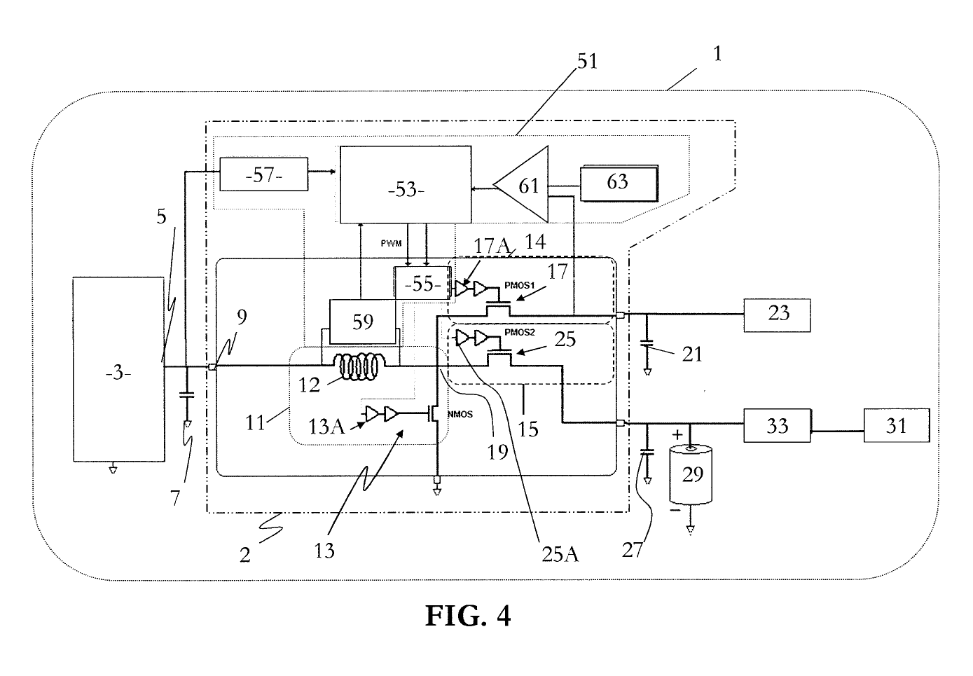

We now refer to FIG. 4 showing another embodiment of the present invention.

This embodiment is distinguished from that of FIG. 1 by the fact that the converter circuit 2 has a second output circuit 15.

While the first output circuit is connected to the electrical load 23 for direct consumption, the second output circuit 15 is connected to an electrical accumulator 29 for storage of the output therein for subsequent consumption.

This makes it possible to increase the quantity of energy tapped from the electrical source 3.

Upstream, the second output circuit 15 is connected via a second variable-size switch 25 to the output terminal 19 of the chopper circuit 11.

Downstream, the second output circuit 15 is connected via a low-pass filter 27 to an electrical energy accumulator belonging to the electronic system 1.

This accumulator 29 may be a capacitor, a super-capacitor, a battery, a micro-cell or a mini-battery.

As FIG. 4 shows, in order to enable a controlled power supply to an electrical load 31 downstream from the electrical accumulator 29, it is possible to provide for a DC-DC voltage regulator 33.

If the energy accumulator 29 is a battery, a micro-cell or a mini-battery, then it is planned to provide for a charger circuit between the low-pass filter 27 and the accumulator 20 to enable the charging of the battery according to the conditions associated with the technology of the battery to avoid heating and/or premature deterioration.

In a first variant, the load 31 and the load 23 are identical. In this case, the electrical energy accumulator 29 is used for example to power the load 23 when the energy produced by the source 3 is not sufficient for a direct power supply to the load 23. In a photovoltaic cell used as an electrical energy source 3, this may be the case for example at night or when the sunlight is too weak, for example under cloudy skies.

In a second variant, the loads 23 and 31 are different and correspond to different electrical consumers.

It can easily be seen that full control of the losses of the switches 13, 17 and 19 is important, given that the number of switches and the number of switching operations per charging/discharging cycle has been increased. The fact of furthermore controlling the size of the switches 13, 17 and 25 as a function of the power delivered by the electrical energy source 3, and/or as a function of the duty cycle, especially when it is determined by an MPPT tracking method, proves to be important for an optimizing of the total efficiency of the converter circuit 2.

For the control of the variable-size switches 17 and 25 whose open or closed state determines whether the output 19 of the chopper circuit 11 is directly connected to the load 23 or to the electrical energy accumulator 29, the control circuit 51 has a hysteresis comparator 61 having one input connected to the first output circuit 14 and its other input connected to a reference 63, the output of the comparator being connected to an input of the control unit 53.

In operation, the control unit 53 controls the generator 55 so that:
when the switch 13 is closed (on), the switch 17 is open (off),
when the switch 17 is closer (on), the switch 13 is open (off).

Thus, at a given point in time, only one of the switches 13 or 17 cannot be open, the other two being closed.

Here below, a detailed description shall be given of the converter circuit 2 of FIG. 4.

The converter of FIG. 4 works around the maximum power point MPP in the same way as the circuit of FIG. 1.

Thus, the converter circuit 2 oscillates about the maximum power point MPP thus guaranteeing the harvesting of a maximum power available at the source.

As stated here above, when the switch 13 is closed, the switches 17 and 25 are open and the inductor is crossed by a current given by the source 3 setting up a magnetic field.

Then, the switch 13 is open and the electrical power can be provided either directly to the load 23 for direct consumption by opening the switch 17 or stored in the accumulator 29 for subsequent consumption.

The output circuit 14 therefore works together with the chopper circuit 11 as a voltage regulator.

Thus, when the switch 13 is open, the switch 17 opens if the output voltage is included in a range of set values of output voltage.

This range of set values is defined by means of the hysteresis comparator 61 and the reference 63.

When the output voltage is out of the range of set values, the control unit 53 receives a corresponding signal from the comparator 61 and commands the opening of the switch 25 if the switch 13 is still open.

Thus, the electrical energy generated by the source 3 can be harvested optimally either for direct consumption by the load 23 or for charging the accumulator 29.

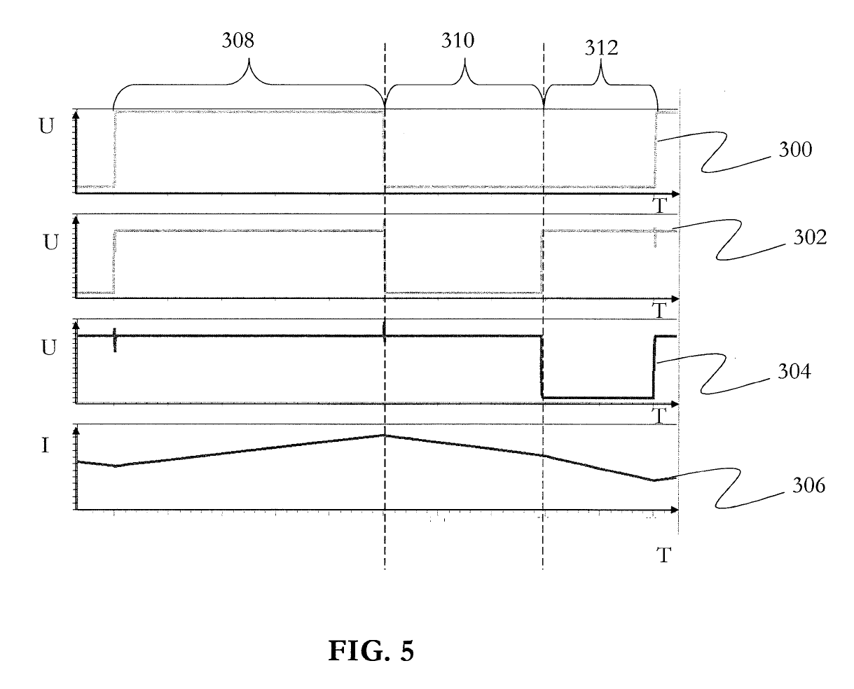

This operation is also illustrated in FIG. 5.

The curves 300, 302 and 304 respectively show the control voltages U of the switches 13, 17 and 25 as a function of time. It may be recalled that the switch 13 is an NMOS type transistor while the variable-size switches 17 and 25 are of the PMOS type in the present exemplary embodiment.

The curve 306 shows the progress of the current at the output terminal 19.

Thus, during the time slot 308, the control voltage for the switches 13, 17 and 25 is at a high level, signifying that the NMOS transistor 13 is on and the inductor 13 is charged while the PMOS transistors 17 and 25 are in the off state.

Then, during the time slot 310, the control voltage for the switches 13 and 17 is at a low level, meaning that the NMOS transistor 13 is off and the inductor 12 is discharged by the output circuit 14 (see curve 306) since the PMOS transistor 25 is powered by a high-level voltage and is therefore in the “on” state. The duration of this time slot 310 depends on whether the output voltage is included in the range of set values. It therefore depends on the energy produced by the source and the current consumed by the load 23.

When the output voltage is outside the range of set values of output voltage and when the output voltage from the NMOS switch is still at the low level, therefore in the off state, the switch 17 passes, during the time slot 12, into the off state while the switch 25 passes to the on state and the inductor now is discharged into the output circuit 15 to recharge the accumulator 29.

The use of the energy stored in the accumulator 29, for example by the load 31, is done conventionally, if need be, through the regulator 33 and shall not be described in greater detail.

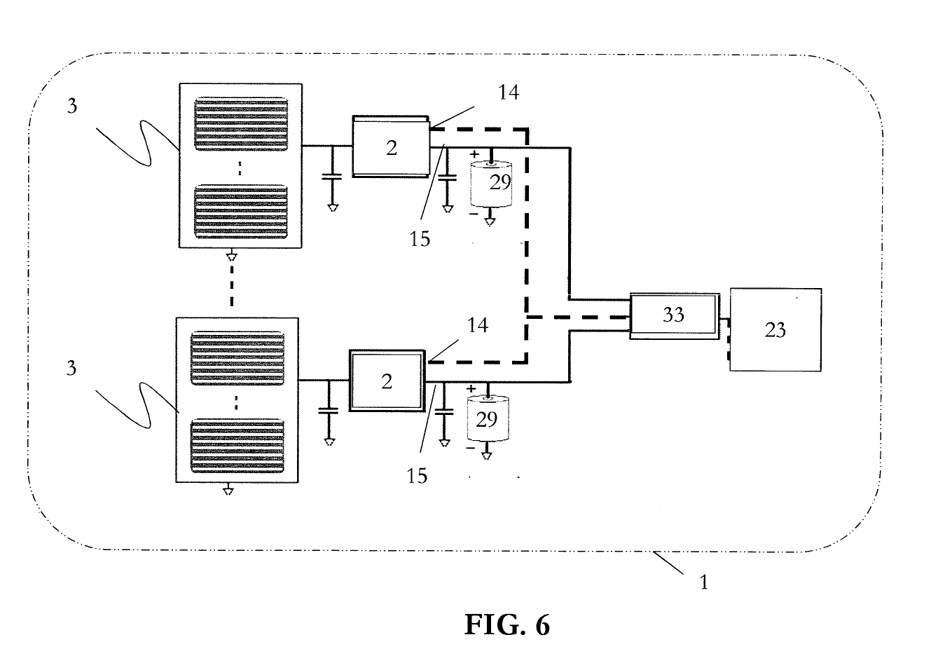

FIG. 6 is a diagram of an electrical system comprising several photovoltaic cells, each of which is associated with a converter circuit 12 like that of FIG. 4 for example.

In this case, the first output circuits 14 are connected together to provide a local stabilized power supply and each of the second output circuits 15 of the converter circuits 2 includes a super-capacitor as well as a DC-DC voltage regulator 33.

The energy harvesting is thus optimized since the cells are made independent of one another, thus preventing a cell, for example a cell in the shade, from becoming a load for the other cells and from causing the efficiency of energy harvesting to drop.

Furthermore, an assembly of this kind makes each of the cells be capable of functioning at its maximum power point independently of the other photovoltaic cells.

Finally, when the super-capacitor is sufficiently charged, it can deliver its energy through the regulator 33.

It can be understood therefore that the converter circuit 2 of the invention enables an optimization of energy harvesting by reducing losses at the level of the power switches.

The circuit can also be distinguished by its simplicity of operation and its low requirements in terms of energy and computation resources.

In particular, for autonomous sensors, it enables a smaller sizing of the cells/batteries powering the sensor when the source does not provide sufficient energy or does not provide energy at all.

1. A converter circuit for connecting to a source of electrical energy, said source being capable of major fluctuations in delivered power, said converter circuit comprising:
a chopper circuit having a variable duty cycle, said chopper circuit including a variable-size chopper switch and an input terminal connectable to said electric energy source,
at least one first output circuit adapted to being connected via a variable-size chopper switch to an output terminal of the chopper circuit; and
a control circuit configured to control firstly the duty cycle of the chopper circuit and secondly the size of said variable-size switches as a function of the power delivered by said electrical energy source.

2. The converter circuit of claim 1, wherein the control circuit is configured to control the sizes of said variable-size switches as a function of the duty cycle.

3. The converter circuit of claim 2, wherein the control circuit is configured for maximum power point tracking.

4. The converter circuit of claim 3, wherein said control circuit is configured to determine a power point according to variations in voltage of said electrical energy source.

5. The converter circuit of claim 1, wherein each of said variable-size switches comprises at least two individual switches that are parallel-mounted and selectively switchable according to a command from said control circuit.

6. The converter circuit of claim 5, wherein the individual switches have the same sizes.

7. The converter circuit of claim 5, wherein the individual switches have increasing sizes.

8. The converter circuit of claim 7, wherein the individual switches have sizes that increase by multiples of two.

9. The converter circuit of claim 1, wherein said control circuit is configured to cause an increase in the size of said variable-size switches as a function of an increase in power delivered by said energy source.

10. The converter circuit of claim 9, wherein the control circuit is configured to control the size of said variable-size switches as a function of predefined ranges of set values of power delivered by said energy source.

11. The converter circuit of claim 1, wherein said control circuit is configured to control the chopper circuit in discontinuous operation mode.

12. The conveter circuit of claim 1, further comprising
a second output circuit adapted to being connected via a second variable-size switch to the output terminal of the chopper circuit, and
wherein said control circuit is configured to cause the switching of the first and second switches as a function of a range of set values of output voltage for the first output circuit.

13. The converter circuit of claim 12, wherein the first output circuit is to be connected to an electrical load working in a range of set values of voltage, and wherein the second output circuit is to be connected to an electrical energy accumulator.

14. The converter circuit of claim 13, wherein the control circuit comprises
a hysteresis comparator having a first input connected to the first output circuit and a second input connected to a reference, an output of the comparator being connected to an input of a control unit controlling a command generator, two outputs of which are respectively connected to the first and second switches in order to drive said first and second switches respectively.

15. The converter circuit of claim 13, wherein said electrical energy accumulator comprises a rechargeable micro-battery.

16. The converter circuit of claim 13, wherein the electrical energy accumulator comprises a super-capacitor.

17. The converter circuit of claim 1, wherein said output circuits comprise low-pass filters.

18. The converter circuit of claim 1, wherein said control circuit further comprises means for:
determining voltages of the terminals of said electrical energy source for two duty cycles that differ by a predefined quantity,
computing a difference between the voltages to obtain a first voltage difference,
comparing said first voltage difference with a second voltage difference, said second voltage difference representing a difference between voltages of said terminals, said second voltage difference having been obtained prior to said first voltage difference, and
causing a change in the duty cycle by a predetermined quantity as a function of a result of the comparison.

19. The converter circuit of claim 18, wherein the control circuit is configured to cause an increase in the duty cycle by a predefined quantity if a previous reduction of the duty cycle resulted in a reduction of the difference in voltage relative to that obtained during the predetermined determining operation.

20. The converter circuit of claim 19, wherein the control circuit is configured to cause a reduction in the duty cycle by a predefined quantity if a previous increase in the duty cycle resulted in a reduction in the difference in voltage relative to that obtained during the previous determining operation

21. The converter circuit of claim 1, wherein the chopper circuit comprises an electrical energy accumulation inductor and at least one chopper switch controlled by the control circuit.

22. The converter circuit of claim 21, wherein the electrical energy accumulation inductor and the chopper switch are laid out in a voltage-boosting configuration.

23. The converter circuit of claim 21, wherein the electrical energy accumulation inductor and the chopper switch are laid out in a voltage-step-down configuration

24. The converter circuit of claim 21, wherein the control circuit includes a sensor of a zero current point of the electrical energy accumulation inductor to trigger the control of at least one switch.

25. An electronic system comprising at least one electrical energy source capable of undergoing major fluctuations, and at least one converter circuit as recited in claim 1 connected to the at least one energy source.

26. The electronic system of claim 25, wherein said source comprises at least one photovoltaic cell.

27. The electronic system of claim 25, wherein said source comprises at least one wind power generator.

28. The electronic system of claim 25, wherein said source comprises at least one thermo-electrical element.
